(19) United States
(12) Patent Application Publication
(10) Pub. No.: US 2024/0203271 A1
(43) Pub. Date: Jun. 20, 2024

(54) METHOD FOR ASSISTING THE PILOTING OF AN AIRCRAFT

(71) Applicant: Airbus SAS, BLAGNAC (FR)

(72) Inventor: Kamel ABDELLI, TOULOUSE (FR)

(21) Appl. No.: 18/541,581

(22) Filed: Dec. 15, 2023

(30) Foreign Application Priority Data
Dec. 19, 2022 (FR) 2213861

(51) Int. Cl. G08G 5/04; G08G 5/00

(52) U.S. Cl. CPC G08G 5/045; G08G 5/0047

(57) ABSTRACT

A method for assisting the piloting of an aircraft includes the following steps: detecting obstacles in an environment of the aircraft; determining a protection zone surrounding each detected obstacle; determining an initial trajectory followed by the aircraft; if the initial trajectory enters a protection zone, determining a corrected trajectory such that the aircraft avoids the protection zone; applying the corrected trajectory to the aircraft; and outputting at least one haptic alert in a flight control stick of the aircraft, the haptic alert indicating a direction of deflection applied to the aircraft when applying the corrected trajectory. Piloting is thus assisted by providing ergonomic and simple alerts, so as to guarantee a safe trajectory for the aircraft.

### CROSS-REFERENCES TO RELATED APPLICATIONS

This application claims the benefit of the French patent application No. 2213861 filed on Dec. 19, 2022, the entire disclosures of which are incorporated herein by way of reference.

### FIELD OF THE INVENTION

The invention relates to the field of assisting the piloting of an aircraft, and relates more particularly to the detection of obstacles in the environment of an aircraft.

### BACKGROUND OF THE INVENTION

As is known, piloting an aircraft requires advanced technical skills to master piloting techniques in general, and techniques of piloting an aircraft in particular.

Indeed, the multitudes of commands that exist in an aircraft make it complex to use each aircraft. This diversity of commands requires specialization in a given aircraft. Specialization in the piloting of a single aircraft requires numerous qualification steps in terms of using the aircraft, via the passing of licenses and a count of a number of flying hours.

However, the emerging trend, for the aerial activity of tomorrow, is a set of flying vehicles within the reach of a broader population. In other words, some aircraft of the future will need to be able to be piloted more easily in order to be accessible to a greater number of people with fewer qualifications than those required up to now.

This trend is being confirmed by the onset of eVTOLs (electrical Vertical Take Off and Landing devices), which correspond to a response to what is now called UAM (Urban Air Mobility), that is to say, urban air mobility is tending to invite more people to take control of electric flying machines. A pilot, or what would preferably be referred to as a driver, could be the urban air taxi for anyone wishing to travel in an urban area, which will be limited only by the electrical storage capacity of the batteries supplying the energy for the flight (the main technological constraint at present).

In this context, in order to be able to make urban flight more accessible, it is necessary to provide better ergonomics and better assistance for the pilot.

### SUMMARY OF THE INVENTION

To this end, according to a first aspect, what is proposed is a method for assisting the piloting of an aircraft, the method being implemented by a computing system comprising electronic circuitry. The method comprises the following steps:
detecting obstacles in an environment of the aircraft;
determining a protection zone surrounding each detected obstacle;
determining an initial trajectory followed by the aircraft;
if the initial trajectory enters a protection zone, determining a corrected trajectory on the basis of the initial trajectory of the aircraft and on the basis of the protection zone surrounding each detected obstacle, such that the aircraft avoids the protection zone;
applying the corrected trajectory to the aircraft; and
outputting at least one haptic alert in a flight control stick of the aircraft, the haptic alert indicating a direction of deflection applied to the aircraft when applying the corrected trajectory to the aircraft.

The method according to the invention thus makes it possible to assist a pilot by correcting the trajectory of the aircraft in order to avoid obstacles and by providing ergonomic and simple alerts corresponding to the correction made to the trajectory.

According to one particular provision, the method comprises detecting a landing zone on the initial trajectory followed by the aircraft, the detected landing zone being determined as a destination of the initial trajectory of the aircraft, and a destination of the corrected trajectory coincides with the destination of the initial trajectory.

According to one particular provision, the dimensions of each protection zone are determined in proportion to a speed of the aircraft.

According to one particular provision, when the aircraft is hovering over a point of the environment, the method comprises:
determining a static safety zone around the hovering aircraft, the static safety zone being centered on the aircraft and being static with respect to the point of the environment;
detecting a movement of the hovering aircraft outside the static safety zone;
repositioning the hovering aircraft in the center of the static safety zone; and
outputting at least one haptic alert in the flight control stick of the aircraft, the haptic alert indicating a direction of deflection applied to the aircraft when repositioning the aircraft in the center of the static safety zone.

According to one particular provision, the initial trajectory is determined using data from sensors and detectors chosen from among: an inertial unit, a camera, a lidar, a radar, a satellite positioning system, an attitude determination system.

According to another aspect, what is proposed is a computer program product comprising program code instructions for executing the method according to the invention when the instructions are executed by a processor.

According to another aspect, what is proposed is a non-transient storage medium on which there is stored a computer program comprising program code instructions for executing the method according to the invention when the instructions are read from the non-transient storage medium and executed by at least one processor.

According to another aspect, what is proposed is a computing system comprising electronic circuitry configured to implement assistance with the piloting of an aircraft, comprising the following steps:
detecting obstacles in an environment of the aircraft;
determining a protection zone surrounding each detected obstacle;
determining an initial trajectory followed by the aircraft;
if the initial trajectory enters a protection zone, determining a corrected trajectory on the basis of the initial trajectory of the aircraft and on the basis of the protection zone surrounding each detected obstacle, such that the aircraft avoids the protection zone;
applying the corrected trajectory to the aircraft; and
outputting at least one haptic alert in a flight control stick of the aircraft, the haptic alert indicating a direction of deflection applied to the aircraft when applying the corrected trajectory to the aircraft.

### BRIEF DESCRIPTION OF THE DRAWINGS

The abovementioned features of the invention, as well as others, will become more clearly apparent from reading the following description of at least one exemplary embodiment, the description being given in relation to the appended drawings, in which:

FIG. 1 schematically illustrates a method for assisting the piloting of an aircraft;

FIG. 2 schematically illustrates one example of changing a trajectory of the aircraft on the basis of haptic alerts output in a flight control stick;

FIG. 3 schematically illustrates a step of stabilizing a hovering aircraft;

FIG. 4 schematically illustrates one example of determining a static safety zone around the aircraft; and

FIG. 5 schematically illustrates a hardware layout of a computing system that comprises electronic circuitry for implementing the method for assisting the piloting of an aircraft.

### DETAILED DESCRIPTION OF THE PREFERRED EMBODIMENTS

### Method for Assisting Piloting

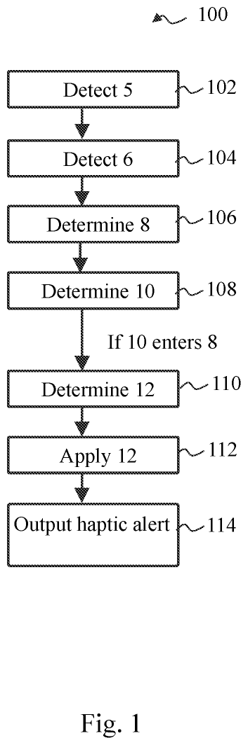

With reference to FIG. 1, according to a first aspect, what is proposed is a method 100 for assisting the piloting of an aircraft 1. The method 100 is implemented by a computing system 200 housed on board the aircraft 1. The computing system 200 is described below.

### Detection of Obstacles and Landing Zones

The method comprises a step 102 of detecting obstacles 5 in an environment of the aircraft 1.

Obstacles 5 in an environment of the aircraft 1 may be detected in several ways by analyzing the environment of the aircraft 1, in particular by analyzing images acquired by one or more cameras and/or by analyzing data acquired by a radar and/or data acquired by a lidar. Other devices for acquiring data from the physical environment of the aircraft 1 may be used in addition or as an alternative. According to one embodiment, a barometric sensor may be used, the barometric sensor determining movements with respect to an air flow; since these examples do not limit the scope of the sensors to be used, it is possible to consider any other equipment that makes it possible either to locate the aircraft 1 with respect to its condition in relation to the air flow, including temperature, pressure, density, etc., or to locate the aircraft 1 in relation to its local position with respect to the obstacles 5 (including the ground), or to locate the position of the aircraft 1 in space with respect to the planet Earth and its local vertical. The analyzed environment is thus located in a region of interest defined by positioning, angular field and range characteristics of the one or more devices for acquiring data from the physical environment of the aircraft 1 (camera field, etc.).

For example, this may be a camera that pivots through 360 degrees, or multiple cameras covering a horizontal field of 360 degrees around the aircraft 1 and a vertical field of 360 degrees around the aircraft 1, this being called 4π steradian vision. Likewise, a radar and/or a lidar may be designed to carry out detections of this same type through 360 degrees all around the aircraft 1. In another example, this may be a camera, a radar and/or a lidar, covering a field of 180 degrees centered in front of the aircraft 1. Other field angle values may be used, consistent with the motion capabilities of the aircraft 1.

According to one particular provision, the environment is analyzed and obstacles 5 are detected (step 102) by fusing images acquired by one or more cameras and data acquired by at least one lidar and/or one radar.

According to one particular provision, the radar and/or lidar detection and the image acquisition may be carried out in longitudinal and transverse planes around the aircraft 1, on the one hand, and along two hemispheres positioned above and below the aircraft 1, on the other hand. This particular provision allows optimum acquisition/detection of obstacles located in the environment of the aircraft 1.

In addition, fusing the images acquired and the data acquired by the radar and/or lidar allows the computing system 200 to carry out three-dimensional modelling of the analyzed environment, using three-dimensional scene reconstruction techniques. Such three-dimensional scene reconstruction techniques are widely disclosed in the prior art and will not be described in more detail here.

By virtue of the three-dimensional modelling, the computing system 200 is furthermore capable, through geometric analysis, of estimating a distance between the aircraft 1 and each of the obstacles 5 detected in the analyzed environment.

According to one embodiment, obstacles 5 are detected by a learning system, or more generally an artificial intelligence system, integrated into the computing system 200. The learning system is capable of recognizing obstacles such as buildings or trees, or any other type of obstacle, by virtue of training dedicated to obstacles potentially encountered during aircraft maneuvers (buildings, trees, power lines, etc.).

Particularly advantageously, in a step 104, the computing system 200 is configured also to detect landing zones 6 in the environment. The landing zones 6 are, for example, defined or marked (for example with a distinctive ground marking). Thus, for example, the computing system 200 is able to recognize a heliport on a building and detect the building as an obstacle 5 while detecting the heliport as a landing zone 6. As will be described below, the detected landing zones 6 are used to determine a destination of the aircraft 1 and to determine an initial trajectory 10.

### Protection Zone

Once the obstacles 5, and possibly the landing zones 6, have been detected (steps 102 and 104), the method 100 comprises a step 106 of determining a protection zone 8 surrounding each detected obstacle 5. This determination may take into account performance characteristics intrinsic to the aircraft, dynamic comfort limitations, and current conditions in relation to the flight physics of the aircraft.

Each protection zone 8 is determined as a three-dimensional zone surrounding each obstacle 5. The limits of each protection zone 8 are positioned at a predetermined distance from the corresponding obstacle 5.

Particularly advantageously, the dimensions of each protection zone 8 are determined in proportion to a speed of the aircraft 1. In other words, the dimensions of each protection zone 8 increase proportionally with the speed of the aircraft 1. Thus, the faster the aircraft 1 is travelling, the greater the dimensions of each protection zone 8, so as to allow avoidance of the obstacle 5 (the more the speed increases, the more an avoidance maneuver should be anticipated).

The aircraft 1 may thus possibly enter the protection zone 8, without risking collision with the obstacle 5, since the dimensions of the protection zone 8 are adapted to allow the aircraft to avoid the obstacle 5.

According to one embodiment, each protection zone 8 is determined in proportion to a speed of the aircraft 1 and performance characteristics intrinsic to the aircraft, dynamic comfort limitations, and current conditions in relation to the flight physics of the aircraft.

### Trajectory Determination

Following the determination of the protection zone 8 surrounding each detected obstacle 5 (step 106), the method comprises a step 108 of determining an initial trajectory 10 followed by the aircraft 1.

According to one particular provision, the initial trajectory 10 is determined using data from sensors and detectors chosen from among: an inertial unit, a camera, a lidar, a radar, a satellite positioning system, an attitude determination system.

According to one particularly advantageous provision, the initial trajectory 10 is determined by fusing the data acquired by the various detectors and sensors listed above.

In addition, as indicated above, during the obstacle 5 detection (step 102), landing zones 6 could be detected (step 104). If a landing zone 6 is located on the initial trajectory 10, then this landing zone 6 is determined as a destination of the initial trajectory 10. According to one particular provision, the destination of the initial trajectory 10 may be a landing zone 6 or an intermediate destination point in space, point in space often being known by the acronym PinS. In this case, the intermediate destination point is indicated beforehand by a pilot of the aircraft, for example by recording the latitude and the longitude of the intermediate destination point.

### Corrected Trajectory

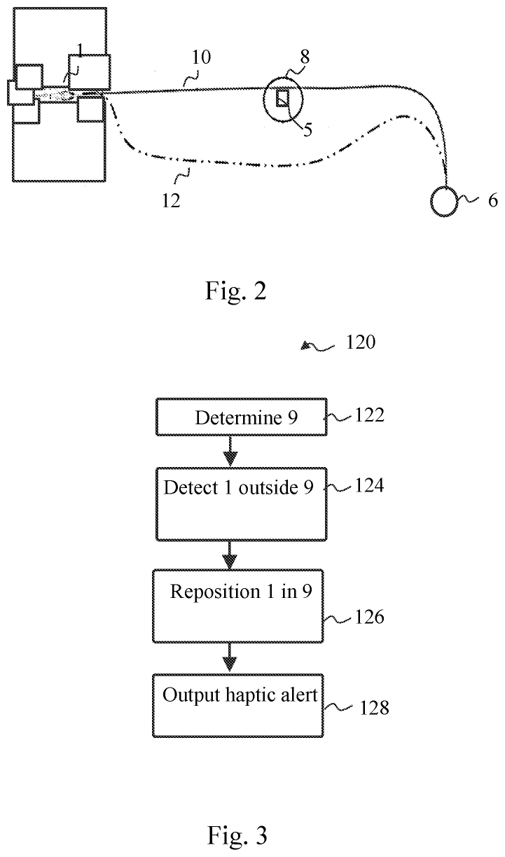

As shown schematically in FIG. 2, if the initial trajectory 10 enters a protection zone 8, then the method comprises a step comprising determining 110 a corrected trajectory 12 on the basis of the initial trajectory 10 of the aircraft 1 and on the basis of the protection zone 8 surrounding each detected obstacle 5, such that the aircraft avoids the protection zone 8.

Particularly advantageously, the corrected trajectory is determined using the destination of the initial trajectory 10. The destination of the corrected trajectory 12 thus coincides with the destination of the initial trajectory 10.

In other words, the corrected trajectory 12 makes it possible to avoid the obstacle 5 and then to resume a trajectory corresponding to the initial trajectory 10.

The corrected trajectory 12 thus determined is applied to the aircraft 1, in a step 112.

The method thus allows the aircraft 1 to avoid an obstacle 5 autonomously, without any intervention by a pilot.

### Haptic Alerts

In a step 114, the computing system 200 outputs haptic alerts in a flight control stick of the aircraft 1 to indicate a direction of deflection applied to the aircraft 1 when applying the corrected trajectory 12 to the aircraft 1.

The outputting of haptic alerts is a particularly advantageous provision of the invention. Indeed, the haptic alerts make it possible to inform the pilot about the behavior of the aircraft 1 and about a change in trajectory. Furthermore, the haptic alerts make it possible to make the movement of the aircraft 1 coincide with the movement of the flight control stick.

According to one particular provision, the haptic alerts may be accompanied by sound alerts and/or light alerts, for example output in a cockpit of the aircraft 1.

### Static Safety Zone

In parallel with the trajectory determination and correction in order to avoid an obstacle 5, the method 100 also comprises a step 120 of stabilizing the hovering of the aircraft 1 above a point of the environment (shown schematically in FIG. 3). Step 120 of stabilizing hovering is implemented when it is detected that the aircraft 1 is hovering. Hovering may be detected via data from avionics systems detecting hovering, or else by determining a combination of factors such as a zero trajectory and a stable altitude.

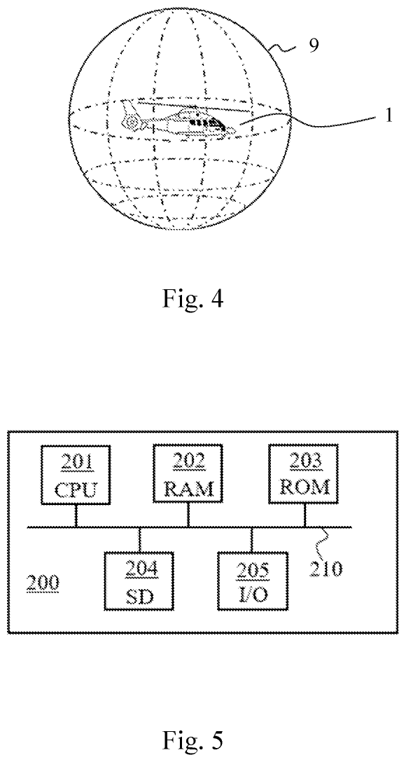

Step 120 of stabilizing hovering first comprises a phase comprising determining 122 a static safety zone 9 around the hovering aircraft 1 (shown schematically in FIG. 4), the static safety zone 9 being centered on the aircraft 1 and being static with respect to the point of the environment. In other words, phase 122 comprises determining a static safety zone 9 that forms a sphere around the aircraft 1. The static safety zone 9 is centered on the aircraft 1, but is fixed with respect to a point on the ground. Thus, once the static safety zone 9 has been determined, the aircraft 1 is able to move in the static safety zone 9.

Next, step 120 of stabilizing hovering comprises a phase 122 comprising detecting a movement of the hovering aircraft 1 outside the static safety zone 9. In other words, this involves detecting whether the aircraft 1 (which is still in a hovering configuration) leaves the static safety zone 9. Such leaving may, for example, be caused by a gust of wind.

If it is detected that the aircraft 1 leaves the static safety zone 9, step 120 of stabilizing hovering comprises a phase 126 comprising repositioning the hovering aircraft 1 in the center of the static safety zone 9, and of outputting 128 at least one haptic alert in the flight control stick of the aircraft 1. In this step, as well as during the trajectory correction, the haptic alert indicates a direction of deflection applied to the aircraft 1 when repositioning the aircraft 1 in the center of the static safety zone 9.

### Computer System

According to another aspect, what is proposed is a computing system 200 comprising electronic circuitry configured to implement a method 100 for assisting the piloting of an aircraft 1.

As shown schematically in FIG. 5, the computing system 200 may comprise the following, connected by a communication bus 210: a processor 201; a random-access memory 202; a read-only memory 203, for example a ROM (read-only memory) or EEPROM (electrically erasable programmable read-only memory); a storage unit 204, such as a hard disk drive (HDD) or a storage medium reader, such as an SD (Secure Digital) card reader; and an input/output interface manager 205.

The processor 201 is capable of executing instructions loaded into the random-access memory 202 from the read-only memory 203, from an external memory, from a storage medium (such as an SD card), or from a communication network. When the computing system 200 is powered up, the processor 201 is capable of reading instructions from the random-access memory 202 and of executing them. These instructions form a computer program allowing the processor 201 to implement the method and the steps described here.

All or part of the method and all or some of the steps described above may thus be implemented in software form through the execution of a set of instructions by a programmable machine, for example a DSP (digital signal processor) or a microcontroller, or be implemented in hardware form by a machine or a dedicated component, for example an FPGA (field-programmable gate array) or ASIC (application-specific integrated circuit) component. Generally speaking, the computing system 200 comprises electronic circuitry designed and configured to implement, in software form and/or hardware form, the method and steps described above in relation to the computing system 200 in question.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for assisting the piloting of an aircraft, the method being implemented by a computing system comprising electronic circuitry and the method being characterized in that it comprises the following steps:
detecting obstacles in an environment of the aircraft;
determining a protection zone surrounding each detected obstacle;
determining an initial trajectory followed by the aircraft;
if the initial trajectory enters a protection zone, determining a corrected trajectory based on the initial trajectory of the aircraft and based on the protection zone surrounding each detected obstacle, such that the aircraft avoids the protection zone;
applying the corrected trajectory to the aircraft; and
outputting at least one haptic alert in a flight control stick of the aircraft, the haptic alert indicating a direction of deflection applied to the aircraft when applying the corrected trajectory to the aircraft.

2. The method according to claim 1, further comprising:
detecting a landing zone on the initial trajectory followed by the aircraft, the detected landing zone being determined as a destination of the initial trajectory of the aircraft, and a destination of the corrected trajectory coincides with the destination of the initial trajectory.

3. The method according to claim 1, wherein dimensions of each protection zone are determined in proportion to a speed of the aircraft.

4. The method according to claim 1, wherein, when the aircraft is hovering over a point of an environment, the method further comprises:
determining a static safety zone around the hovering aircraft, the static safety zone being centered on the aircraft and being static with respect to said point of the environment;
detecting a movement of the hovering aircraft outside the static safety zone;
repositioning the hovering aircraft in the center of the static safety zone; and
outputting at least one haptic alert in a flight control stick of the aircraft, the haptic alert indicating a direction of deflection applied to the aircraft when repositioning the aircraft in a center of the static safety zone.

5. The method according to claim 1, wherein the initial trajectory is determined using data from sensors and detectors chosen from among: an inertial unit, a camera, a lidar, a radar, a satellite positioning system, and an attitude determination system.

6. A non-transient storage medium on which there is stored a computer program comprising program code instructions for executing the method according to claim 1 when said instructions are read from said non-transient storage medium and executed by a processor.

7. A computing system comprising electronic circuitry configured to implement assistance with the piloting of an aircraft, comprising the following steps:
detecting obstacles in an environment of the aircraft;
determining a protection zone surrounding each detected obstacle;
determining an initial trajectory followed by the aircraft;
if the initial trajectory enters a protection zone, determining a corrected trajectory based on the initial trajectory of the aircraft and based on the protection zone surrounding each detected obstacle, such that the aircraft avoids the protection zone;
applying the corrected trajectory to the aircraft; and
outputting at least one haptic alert in a flight control stick of the aircraft, the haptic alert indicating a direction of deflection applied to the aircraft when applying the corrected trajectory to the aircraft.
